(19) United States
(12) Patent Application Publication
(10) Pub. No.: US 2018/0293212 A1
(43) Pub. Date: Oct. 11, 2018

(54) Website Production System

(71) Applicant: Yung-Yen Chen, New Taipei City (TW)

(72) Inventor: Yung-Yen Chen, New Taipei City (TW)

(21) Appl. No.: 15/690,729

(22) Filed: Aug. 30, 2017

(30) Foreign Application Priority Data
Apr. 11, 2017 (TW) 106112067

(51) Int. Cl. G06F 17/22; H04L 29/08; G06F 17/21; G06F 17/24; G06Q 30/02; G06Q 30/04

(52) U.S. Cl. CPC G06F 17/2205; H04L 67/02; G06F 17/212; G06F 17/2235; G06Q 30/0601; G06Q 30/0223; G06Q 30/04; G06Q 30/0277; G06F 17/245

(57) ABSTRACT

A website production system has a layout setting module, a webpage processing module and a cloud uploading module. The layout setting module adjusts positions of a public information and a date information to generate an edited position information. The layout setting module edits a list header of the public information and a context corresponding to the list header to generate an edited context information. The layout setting module sets a table and adjusts a size of a text image of the public information depending on the size of table. The webpage processing module converts the edited position information and the edited context information into the webpage and encodes the webpage into a first and second encoded webpages, and then the cloud uploading module uploads and posts the first and second encoded webpages to the internet.

### CROSS-REFERENCE TO RELATED APPLICATION

This application claims priority from Taiwan Application No. 106112067, filed on Apr. 11, 2017, in the Taiwan Intellectual Property Office, the content of which is hereby incorporated by reference in their entirety for all purposes.

### BACKGROUND OF THE INVENTION

### 1. Field of the Invention

The present disclosure relates to a production system. In particularly, the present disclosure relates to a website production system for producing a website.

### 2. Description of the Related Art

In the era of progressing continually scientific and technological progress, with the rapid development of the Internet, more and more manufacturers have been turned to sell the products via the internet, instead of the retail store as in the past, thereby saving the rent of the retail store. The products are not be longer limited to be sold to the local consumers, but also can be sold to the consumers in other countries, such that the manufacturers have more business opportunities to earn more money.

Of course, there are many internet-based sales platforms on the market, everyone can put the products on the internet-based sales platforms, but cannot add other functions according to their own needs due to the limited functionality of the internet-based sales platforms. Although it is also possible to set up the website and add other functions as needed by using the programming languages by oneself, it need to take a lot of times and effort to set up the website, which become a more difficult thing for those who are not familiar with the programming languages. Therefore, how to create the website required by the user in a simple way becomes a problem to be solved.

### SUMMARY OF THE INVENTION

In view of the above-mentioned problems of the related art, the object of the present disclosure is to provide a website production system to solve the problems of the related art.

Based on the object described above, the present disclosure provides a website production system, comprising a layout setting module, a webpage processing module and a cloud uploading module. The layout setting module comprises a personalized position setting unit, a content editing unit and a table setting unit. The personalized position setting unit is configured to provide a plurality of information options and a plurality of date options, wherein the plurality of information options respectively correspond to a public information and the plurality of date options respectively correspond to a date information of the public information, and the plurality of information options and the plurality of date options are provided for personalized adjustment of relative positions of the public information and the date information on a webpage to generate an edited position information. The content editing unit is configured to edit the content of the public information, the content editing unit comprises a list editing unit and a context editing unit, the list editing unit edits at least one list header of the public information, the context editing unit edits a context of the list header of the public information to generate an edited context information, wherein the context comprises a text portion, at least one text image or at least one product image. The table setting unit is configured to provide a context editing interface to the context editing unit, the context editing interface comprises a table setting option for setting at least one table and a size option for determining a size of the table, the table setting option and the size option are configured for the table such that a size of the text image of the list header of the public information is adjustable, wherein the table is arranged into an N×M array and N and M are positive integers. The webpage processing module is configured to convert the edited position information and the edited context information into the webpage, and the webpage processing module comprises a first encoder and a second encoder respectively used to encode the webpage into a first encoded webpage and a second encoded webpage, wherein the first encoded webpage corresponds to a desktop electronic device and the second encoded webpage corresponds to an external electronic mobile device. The cloud uploading module is electrically connected to the webpage processing module, and the cloud uploading module is configured to upload and post the first encoded webpage and the second encoded webpage to an internet.

Preferably, the website production system further comprises a context hyperlink unit configured to establish a context hyperlink to the text image or a segment of the text portion of the list header of the public information.

Preferably, the size option is provided for adjusting the size of the table according to the pixels of different types of display windows of the desktop electronic device or the external electronic mobile device.

Preferably, the website production system further comprises a product setting unit, the product setting unit comprises a plurality of image upload fields and a plurality of product fields, the product image of the list header of the public information is uploaded to the plurality of image upload fields, the information of the product image is edited in the plurality of product fields, and the plurality of product fields and the plurality of image upload fields are not required to be filled fully.

Preferably, the website production system further comprises a marquee unit, the at least one product image selected from the product images of the list header of the public information is uploaded to the marquee unit, and the marquee unit encodes the product images and cyclically plays the product images depending on a sequence of encoding the product images.

Preferably, the production system further comprises a billing unit, which makes a bill when each time the consumer clicks the product field of the at least one product image for purchase.

Preferably, the production system further comprises a discount unit, which writes a discount on the bill when a quantity of clicking the product field of the product image by the consumer reaches a quantity required for the discount.

Preferably, the production system further comprises a membership unit, which classifies the consumers into a plurality of membership categories depending on a cumulative amount of money generated by clicking the product field of the at least one product image for purchase by the consumer.

Preferably, the plurality of membership categories comprises an ordinary member, a bronze membership, a silver membership, a gold membership, a platinum membership and a diamond membership.

Preferably, the website production system further comprises an advertisement setting unit, which comprises an advertisement editing unit for editing information related to at least one advertisement and an advertisement hyperlink unit for establishing a hyperlink to the advertisement.

As mentioned above, the website production system of the present disclosure may have the one or more of the following advantages:

(1) According to the website production system of the present disclosure, the table setting option and the size option are configured for the table such that a size of the text image of the list header of the public information is adjusted without being excessively enlarged.

(2) According to the website production system of the present disclosure, the website is posted to the desktop electronic device and the external electronic mobile device at the same time.

(3) The website production system of the present disclosure classifies the consumers into a plurality of categories depending on a cumulative amount of money of the product purchased by the consumer.

### BRIEF DESCRIPTION OF THE DRAWINGS

FIG. 1 is a block diagram of a first embodiment of the website production system of the present disclosure.

FIG. 2 is a block diagram of a second embodiment of the website production system of the present disclosure.

FIG. 3 is a block diagram of a third embodiment of the website production system of the present disclosure.

FIG. 4 is a block diagram of a fourth embodiment of the website production system of the present disclosure.

### DETAILED DESCRIPTION OF THE EXEMPLARY EMBODIMENTS

The advantages, features and technical methods to achieve the present disclosure are described in more detail with reference to the exemplary embodiments and the accompanying drawings for a better understanding of them, and the present disclosure may be implemented in different forms, and should not be construed to be limited embodiments herein, on the contrary, the embodiments provided herein make the disclosure more clear and comprehensive and the scope of the present disclosure is fully transmitted to those skilled in the art, and the present disclosure is will be only defined by the accompanying claims.

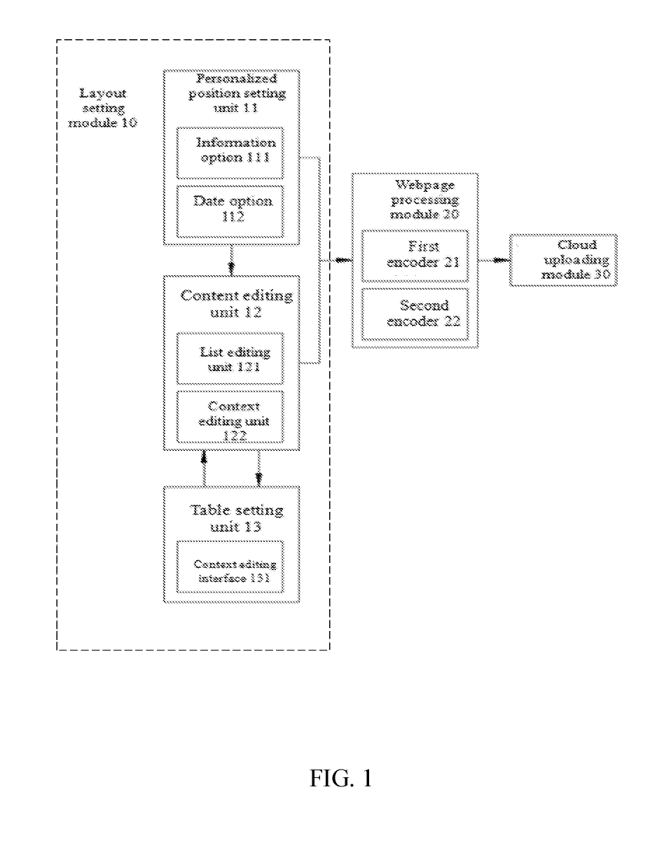

Refer to FIG. 1, and FIG. 1 is a block diagram of a first embodiment of the website production system of the present disclosure. In the first embodiment, the website production system comprises a layout setting module 10, a webpage processing module 20 and a cloud uploading module 30. The layout setting module 10 comprises a personalized position setting unit 11, a content editing unit 12 and a table setting unit 13. The personalized position setting unit 11 is configured to provide a plurality of information options 111 respectively corresponding to a public information, and a plurality of date options 112 respectively corresponding to a date information of the public information that may be shown or hided selectively. The plurality of information options 111 and the plurality of date options 112 are configured for personalized adjustment of relative positions of the plurality of information options and the plurality of date options on a webpage to generate an edited position information. The content editing unit 12 is configured to edit the content of the public information, the content editing unit 12 comprises a list editing unit 121 and a context editing unit 122. The list editing unit 121 edits at least one list header of the public information, the context editing unit 122 edits the context of the list header of the public information to generate an edited context information, wherein the context comprises a text portion, at least one text image or at least one product image. The table setting unit 13 is configured to provide a context editing interface 131 to the context editing unit 122, the context editing interface 131 comprises a table setting option for setting at least one table and a size option for determining a size of the table. The table setting option and the size option are configured for the table such that a size of the text image of the list header of the public information is adjustable, wherein the table is arranged into an N×M array, and N and M are positive integers. Furthermore, the size option is provided for adjusting a size of the table according to pixels of different types of display windows of the desktop electronic device or the external electronic mobile device, such that the text image of the list header of the public information may not be excessively enlarged or excessively shrunk. The webpage processing module 20 is configured to convert the edited position information and the edited context information into the webpage. The webpage processing module 20 comprises a first encoder 21 and a second encoder 22 respectively used to encode the webpage into a first encoded webpage and a second encoded webpage, wherein the first encoded webpage corresponds to a desktop electronic device such as a desktop computer or a notebook computer, and the second encoded webpage corresponds to an external electronic mobile device such as a cell phone or a tablet computer. The cloud uploading module 30 is electrically connected to the webpage processing module 20, and configured to upload and post the first and the second encoded webpages to an internet.

It is worth noting that the context editing unit 122 directly inputs the text portion and the text image of the list header of the public information to edit them. When the user edits the text portion of the list header of the public information, the user may directly input the text portion and rearrange the text portion together with the image without controlling the layout of the text portion and the image by writing the programming language (such as HTML or C language) or applying a dragging manner, thereby reducing editing complexity, and the format of the image is not limited and thus the user is not need to worry the mismatch problem of the file format.

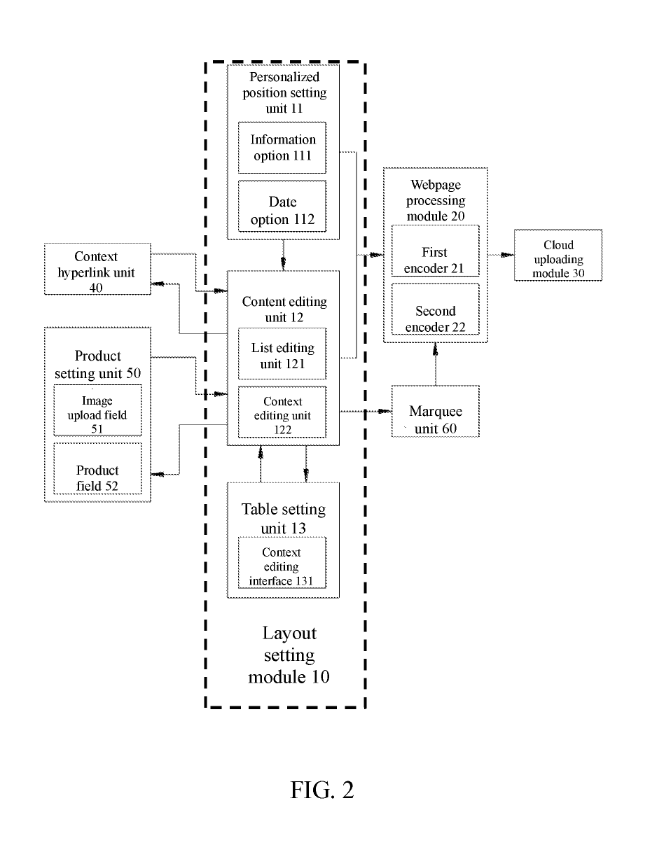

Referring to FIG. 2, FIG. 2 is a block diagram of a second embodiment of the website production system of the present disclosure. In the second embodiment, the components represented by the same reference numbers have the similar configurations as the components described above, not repeat them here.

As shown in FIG. 2, the website production system further comprises a context hyperlink unit 40 and a product setting unit 50. The context hyperlink unit 40 establishes a context hyperlink to the text image or a segment of the text portion of the list header of the public information, such that it is turned to other websites by directly clicking the text image or a segment of the text portion by the user who browses the website without spending time in searching the text image or a segment of the text portion on the webpages. The product setting unit 50 comprises a plurality of image upload fields 51 and a plurality of product fields 52, the product image of the list header of the public information is uploaded to the plurality of image upload fields 51, and the information of the product image is edited in the plurality of product fields 52, thereby making it easier for the users to edit the relative product information. Furthermore, the plurality of product fields 52 and the plurality of image upload fields 51 are not need to be fill fully, taking into consideration that some of the vended products belong to the labor categories or do not have the actual appearance, such as cleaning or legal advice, which do not have color or actual shape feature, thereby facilitating the user to edit the such products, and the plurality of product fields 52 places the products of the same categories in the same positions, such that the user can clearly know that what kind of product is being edited by the user.

In addition, the website production system further comprises a marquee unit 60, the at least one product image selected from the product images of the title of the list of the public information is uploaded to the marquee unit 60, and the marquee unit 60 encodes the product images and cyclically plays the product images depending on a sequence of encoding the product images, thereby making the contents of the website more abundant and increasing an exposure rate of the product. When the product image of the marquee unit 60 is clicked, the product image may be enlarged to improve sharpness thereof, thereby facilitating the user to browse the product.

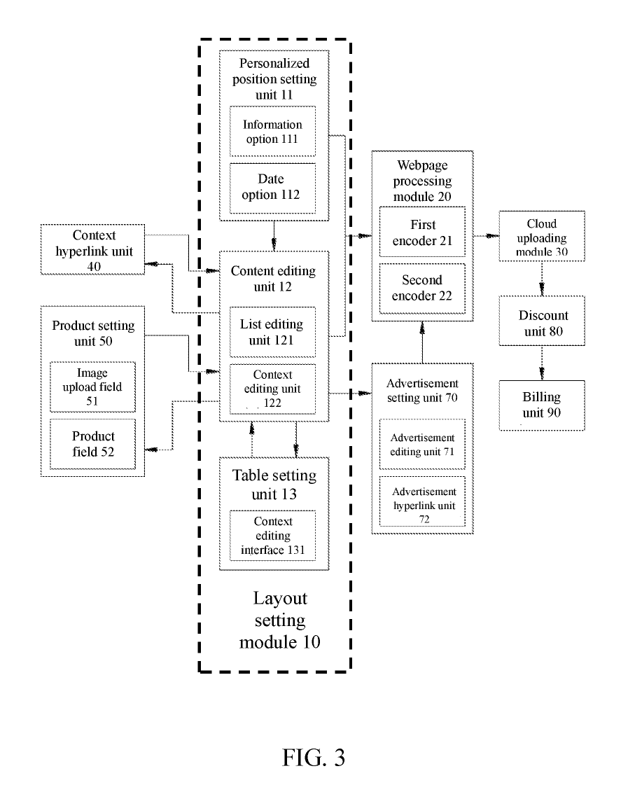

Referring to FIG. 3, FIG. 3 is a block diagram of a third embodiment of the website production system of the present disclosure. In the third embodiment, the components represented by the same reference numbers have the similar configurations as the components described above, not repeat them here.

As shown in FIG. 3, the website production system further comprises an advertisement setting unit 70, the advertisement setting unit 70 comprises an advertisement editing unit 71 and an advertisement hyperlink unit 72, the advertisement editing unit 71 edits the information related to at least one advertisement, and the advertisement hyperlink unit establishes a hyperlink to the advertisement. It is easier for users to edit the advertisement with assistance of the advertisement editing unit 71 and the advertisement hyperlink unit 72, and the user may earn the additional benefits from lease of the advertisement.

In particular, the website production system of the present embodiment further comprises a discount unit 80 and a billing unit 90. The billing unit 90 makes a bill for each time the consumer clicks the product field 52 of the at least one product image for purchase, such that the user does not need to personally calculate the bill so as to facilitate the user and the consumer to checkout payments, thereby preventing they from occurring money disputes. In addition, the discount unit 80 writes a discount on the bill when a quantity of clicking the product field 52 of the product image by the consumer reaches a quantity required for discount, thereby making the user more understand consuming ability of the consumer.

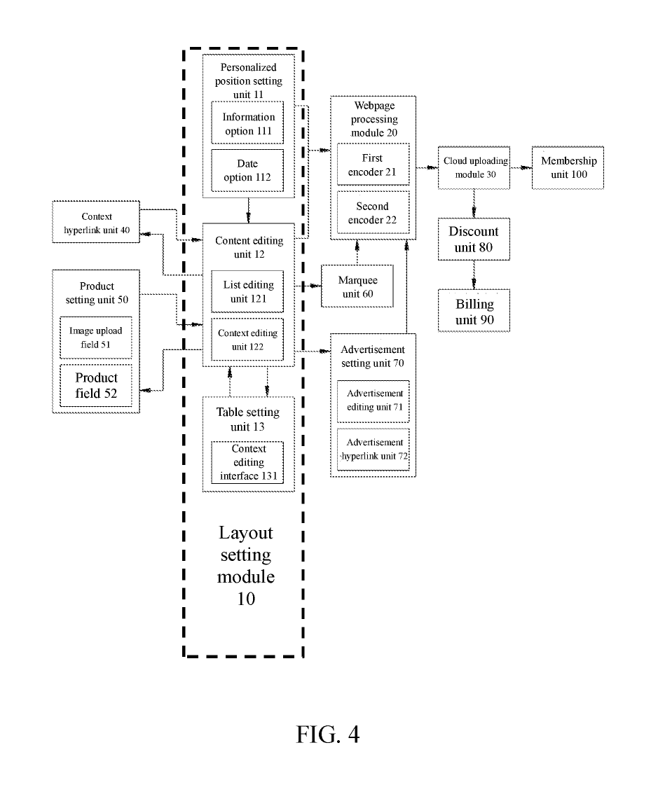

Referring to FIG. 4, FIG. 4 is a block diagram of a fourth embodiment of the website production system of the present disclosure. In the fourth embodiment, the components represented by the same reference numbers have the similar configurations as the components described above, not repeat them here.

As shown in FIG. 4, the website production system further comprises a membership unit 100, which classifies the consumers into a plurality of membership categories depending on a cumulative amount of money generated by clicking the product field 52 of the product image for purchase by the consumer. The plurality of membership categories comprise a ordinary member, a bronze membership, a silver membership, a gold membership, a platinum membership and a diamond membership, and the sequence of the ordinary member to the diamond depends on the cumulative amount of money from low to high, such that the user more understands the consumer's consumption level so as to pay attention to the important consumer groups and mail the relative information of new product to them. In addition, the website production system of the present embodiment is also linked to the social website such that the consumer may conveniently share and review the website, an exposure rate of the website increases and more people know the existence of the website, thereby bringing considerable benefits to the user.

In summary, the website production system of the present disclosure comprises the table setting unit 13 and the product setting unit 50 such that the user can easily edit and arrange the text image and the product image, and the website production system of the present disclosure further comprises the first encoder 21 and the second encoder 22 such that the website may be posted to the desktop electronic device and the external electronic mobile device at the same time. In addition, the website production system of the present disclosure further comprises the discount unit 80 and the billing unit 90 used to facilitate the user and the consumer to checkout payments, thereby preventing from occurring money disputes between them. In addition, the website production system of the present disclosure further comprises the membership unit 100, such that the user more understands the consumer's consumption level so as to pay attention to the important consumer groups and mail the relative information of new product to them. In summary, the website production system of the present disclosure has the above-described advantages, and thus the user can easily set up website and understand the consumer's consumption level.

The above-described embodiments are merely an exemplary illustration, and the present disclosure is not limited thereto. Any equivalent modification or change may be made thereto without departing from the scope and the spirit of the present disclosure and is covered by the appended claims.

What is claimed is:

1. A website production system, comprising:
a layout setting module comprising:
a personalized position setting unit configured to provide a plurality of information options and a plurality of date options, wherein the plurality of information options respectively correspond to a public information and the plurality of date options respectively correspond to a date information of the public information, and the plurality of information options and the plurality of date options are provided for personalized adjustment of relative positions of the public information and the date information on a webpage to generate an edited position information;
a content editing unit configured to edit the content of the public information, the content editing unit comprises a list editing unit and a context editing unit, the list editing unit edits at least one list header of the public information, the context editing unit edits a context of the list header of the public information to generate an edited context information, wherein the context comprises a text portion, at least one text image or at least one product image; and
a table setting unit configured to provide a context editing interface to the context editing unit, the context editing interface comprises a table setting option for setting at least one table and a size option for determining a size of the table, the table setting option and the size option are configured for the table such that a size of the text image of the list header of the public information is adjustable, wherein the table is arranged into an N×M array and N and M are positive integers;
a webpage processing module configured to convert the edited position information and the edited context information into the webpage, and the webpage processing module comprises a first encoder and a second encoder respectively used to encode the webpage into a first encoded webpage and a second encoded webpage, wherein the first encoded webpage corresponds to a desktop electronic device and the second encoded webpage corresponds to an external electronic mobile device; and
a cloud uploading module electrically connected to the webpage processing module, and the cloud uploading module is configured to upload and post the first encoded webpage and the second encoded webpage to an internet.

2. The website production system of claim 1, further comprising a context hyperlink unit configured to establish a context hyperlink to the text image or a segment of the text portion of the list header of the public information.

3. The website production system of claim 1, wherein the size option is provided for adjusting the size of the table according to the pixels of different types of display windows of the desktop electronic device or the external electronic mobile device.

4. The website production system of claim 1, further comprising a product setting unit, the product setting unit comprises a plurality of image upload fields and a plurality of product fields, the product image of the list header of the public information is uploaded to the plurality of image upload fields, the information of the product image is edited in the plurality of product fields, and the plurality of product fields and the plurality of image upload fields are not required to be filled fully.

5. The website production system of claim 1, further comprising a marquee unit, the at least one product image selected from the product images of the list header of the public information is uploaded to the marquee unit, and the marquee unit encodes the product images and cyclically plays the product images depending on a sequence of encoding the product images.

6. The website production system of claim 4, further comprising a billing unit, which makes a bill when each time the consumer clicks the product field of the at least one product image for purchase.

7. The website production system of claim 6, further comprising a discount unit, which writes a discount on the bill when a quantity of clicking the product field of the product image by the consumer reaches a quantity required for the discount.

8. The website production system of claim 4, further comprising a membership unit, which classifies the consumers into a plurality of membership categories depending on a cumulative amount of money generated by clicking the product field of the at least one product image for purchase by the consumer.

9. The website production system of claim 8, wherein the plurality of membership categories comprise a ordinary member, a bronze membership, a silver membership, a gold membership, a platinum membership and a diamond membership.

10. The website production system of claim 1, further comprising an advertisement setting unit, which comprises an advertisement editing unit for editing information related to at least one advertisement and an advertisement hyperlink unit for establishing a hyperlink to the advertisement.
